(19) United States
(12) Patent Application Publication
(10) Pub. No.: US 2024/0014912 A1
(43) Pub. Date: Jan. 11, 2024

(54) STORAGE MEDIUM, WIRELESS COMMUNICATION APPARATUS, AND WIRELESS COMMUNICATION METHOD

(71) Applicant: DENSO CORPORATION, Kariya-city (JP)

(72) Inventor: Eiji YANABU, Kariya-city (JP)

(21) Appl. No.: 18/347,636

(22) Filed: Jul. 6, 2023

(30) Foreign Application Priority Data
Jul. 8, 2022 (JP) 2022-110646

(51) Int. Cl. H04B 17/391; H04W 64/00; H04B 17/318; B60W 60/00; B60W 40/06; B60W 50/06; H04W 12/128

(52) U.S. Cl. CPC H04B 17/391; H04W 64/006; H04B 17/318; B60W 60/001; B60W 40/06; B60W 50/06; H04W 12/128; B60W 2555/00

(57) ABSTRACT

The present disclosure provides a non-transitory tangible storage medium storing a program to be executed by a computer of a wireless communication apparatus. Instructions of the program stored in the storage medium includes: acquiring communication information including at least a position of the wireless communication apparatus and a radio wave intensity of the wireless communication with the base station at the position of the wireless communication apparatus; and transmitting, via the base station, the acquired communication information to a server, the server generating a radio wave state map indicating the radio wave intensity at the position of the wireless communication apparatus based on the received communication information.

### CROSS REFERENCE TO RELATED APPLICATION

The present application claims the benefit of priority from Japanese Patent Application No. 2022-110646 filed on Jul. 8, 2022. The entire disclosure of the above application is incorporated herein by reference.

### TECHNICAL FIELD

The present disclosure relates to a technology of performing communication via a base station in a moving state.

### BACKGROUND

Conventionally, when a wireless communication apparatus, such as a smartphone mounted with a SIM card properly connects to a network by performing wireless communication with a base station, the wireless communication apparatus acquires communication information including at least radio wave intensity of wireless signal transmitted from the base station, and displays the communication information on, for example, a display or the like to notify the communication information to a user. SIM is an abbreviation of subscriber identity module.

### SUMMARY

The present disclosure provides a non-transitory tangible storage medium storing a program to be executed by a computer of a wireless communication apparatus. Instructions of the program stored in the storage medium includes: acquiring communication information including at least a position of the wireless communication apparatus and a radio wave intensity of the wireless communication with the base station at the position of the wireless communication apparatus; and transmitting, via the base station, the acquired communication information to a server, the server generating a radio wave state map indicating the radio wave intensity at the position of the wireless communication apparatus based on the received communication information.

### BRIEF DESCRIPTION OF DRAWINGS

Objects, features and advantages of the present disclosure will become apparent from the following detailed description made with reference to the accompanying drawings. In the drawings:

FIG. 1 is a block diagram illustrating a configuration of a wireless communication system according to an embodiment of the present disclosure;

FIG. 2 is a block diagram illustrating a configuration of a wireless communication apparatus;

FIG. 3 is a radio wave state map generated by a server;

FIG. 4 is a block diagram illustrating functions of the wireless communication apparatus;

FIG. 5 is a sequence diagram illustrating a communication process executed between the wireless communication apparatus and the server; and

FIG. 6 is a sequence diagram illustrating another communication process executed between the wireless communication apparatus and the server.

### DETAILED DESCRIPTION

When the wireless communication apparatus fails to connect to the network by performing wireless communication with the base station, the wireless communication apparatus invalidates the SIM card and notifies the user by displaying the out of service.

In a case where the wireless communication apparatus notifies out of service to the user by display, the user is not sure whether the wireless communication apparatus can receive the wireless signal transmitted from the base station.

Regarding this difficulty, in a known technology, when the wireless communication apparatus fails to connect to the network by performing wireless communication with the base station, the SIM card is invalidated while remaining display of the radio wave intensity for performing the wireless communication with the base station on the wireless communication apparatus such that the user is notified with the radio wave intensity.

After detailed study on the known technology by the inventor of the present disclosure, the inventor has found that communication information including the radio wave intensity at which the wireless communication apparatus wirelessly communicates with the base station cannot be effectively used by only displaying the radio wave intensity of the wireless communication on the wireless communication apparatus.

According to an aspect of the present disclosure, a non-transitory tangible storage medium storing a program to be executed by a computer of a wireless communication apparatus is provided. The wireless communication apparatus performs a wireless communication in a moving state via a base station. Instructions of the program stored in the storage medium includes: acquiring communication information including at least a position of the wireless communication apparatus and a radio wave intensity of the wireless communication with the base station at the position of the wireless communication apparatus; and transmitting, via the base station, the acquired communication information to a server, the server generating a radio wave state map indicating the radio wave intensity at the position of the wireless communication apparatus based on the received communication information.

According to another aspect of the present disclosure, a wireless communication apparatus that performs a wireless communication via a base station in a moving state is provided. The wireless communication apparatus includes: a computer-readable non-transitory storage medium; and a computer, by executing a program stored in the computer-readable non-transitory storage, configured to: acquire communication information including at least a position of the wireless communication apparatus and a radio wave intensity of the wireless communication with the base station at the position of the wireless communication apparatus; and transmit, via the base station, the acquired communication information to a server, the server generating a radio wave state map indicating the radio wave intensity at the position of the wireless communication apparatus based on the received communication information.

According to another aspect of the present disclosure, a wireless communication method executed by a computer of a wireless communication apparatus is provided. The wireless communication apparatus performs a wireless communication via a base station in a moving state. The wireless communication method includes: acquiring communication information including at least a position of the wireless communication apparatus and a radio wave intensity of the wireless communication with the base station at the position of the wireless communication apparatus; and transmitting, via the base station, the acquired communication information to a server, the server generating a radio wave state map indicating the radio wave intensity at the position of the wireless communication apparatus based on the received communication information.

The wireless communication apparatus acquires communication information including at least the position of wireless communication apparatus and the radio wave intensity of wireless communication with the base station at the position of the wireless communication apparatus. The wireless communication apparatus transmits, via the base station, the acquired communication information to the server, which generates the radio wave state map based on the acquired communication information. The server generates the radio wave state map to include the radio wave intensity at the position based on the received communication information.

In the above configurations, since the wireless communication apparatus transmits the communication information including the radio wave intensity of wireless communication with the base station to the server, both of the wireless communication apparatus that performs the wireless communication with the base station and the server can effectively use the communication information acquired by the wireless communication apparatus.

The following will describe embodiments of the present disclosure with reference to the drawings.

### 1. Configuration

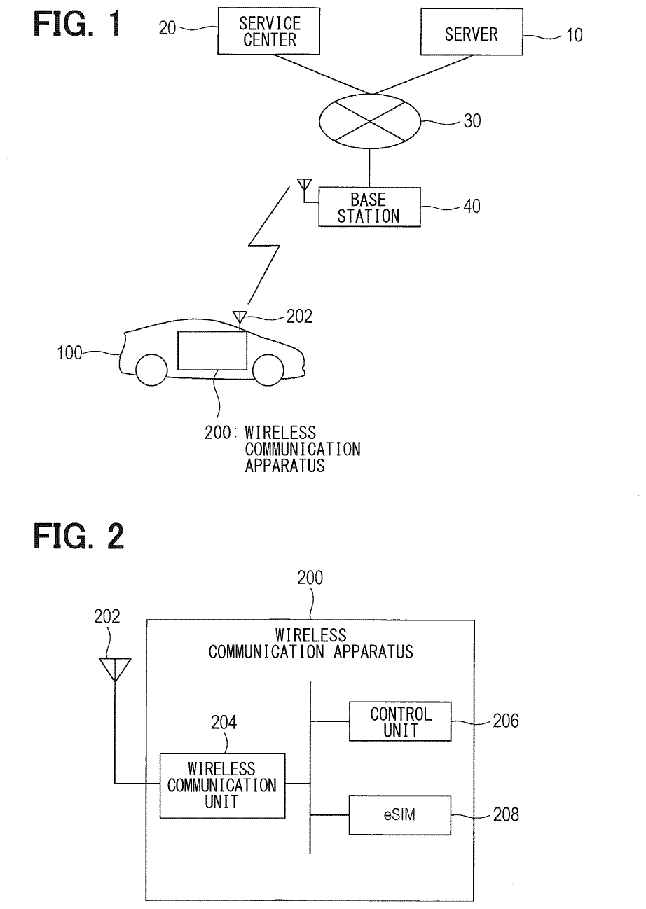

As shown in FIG. 1, a wireless communication system 2 includes a server a service center 20, a network 30, a base station 40, and a wireless communication apparatus 200.

The server 10 communicates with the wireless communication apparatus 200 mounted on a vehicle 100 via the network 30 and the base station 40. For example, the service center 20 may control autonomous driving of the vehicle 100 by communicating with the wireless communication apparatus 200 via the network 30 and the base station 40.

The wireless communication apparatus 200 is mounted on the vehicle 100, and performs wireless communication with the base station 40 located closest to the wireless communication apparatus. The wireless communication apparatus 200 communicates with the server 10 and the service center 20 via the base station 40 and the network 30.

As shown in FIG. 2, the wireless communication apparatus 200 is implemented by a computer, which includes an antenna 202, a wireless communication unit 204, a control unit 206, and an eSIM 208. Herein, eSIM is an abbreviation for embedded subscriber identity module. The wireless communication apparatus 200 communicates with other ECUs via an in-vehicle network provided in the vehicle 100. ECU is an abbreviation for electronic control unit.

The wireless communication unit 204 performs, via the antenna 202, wireless communication with the base station 40, which is located closest to the wireless communication apparatus 200. The control unit 206 may be implemented by a microcomputer, which includes a CPU, a ROM, a RAM, a flash memory, and the like (not illustrated). The wireless communication is performed by the CPU of the control unit 206 by executing a program, which is stored in the ROM, the flash memory, or the eSIM 208.

The eSIM 208 stores subscriber information, communication carrier information, an operation system (OS) such as LINUX, and various application programs. The operation system controls execution of various application programs. Terminal information corresponding to each communication carrier is registered in the eSIM 208. Thus, the wireless communication apparatus 200 can perform wireless communication using a different communication carrier by switching the terminal information to be used.

When the wireless communication apparatus 200 enters a communication area of the base station 40, the wireless communication apparatus 200 acquires, from the base station 40, information, such as the communication carrier name, a position of the base station 40, a generation of communication, and a radio wave intensity. Each wireless communication apparatus 200 in the communication area of base station 40 transmits, in addition to the information acquired from the base station 40, a position of the vehicle 100, that is, a position of the wireless communication apparatus 200 as communication information (COMM INFO) to the server 10 via the base station 40 and the network 30.

When the wireless communication apparatus 200 transmits data to the server 10 via the base station 40 and the network 30 or receives data from the server via the base station 40 and the network 30, it is simply referred to that the wireless communication apparatus 200 transmits data to the server 10 or receives data from the server 10.

When the server 10 transmits data to the wireless communication apparatus 200 via the base station 40 and the network 30 or receives data from the wireless communication apparatus 200 via the base station 40 and the network 30, it is simply referred to that the server 10 transmits data to the wireless communication apparatus 200 or receives data from the wireless communication apparatus 200.

The wireless communication apparatus 200 may acquire the position of wireless communication apparatus 200 from a vehicle navigation system mounted on the vehicle 100. The wireless communication apparatus 200 may acquire the position of itself from a GPS device as long as the position can be acquired by the GPS device included in the wireless communication apparatus 200.

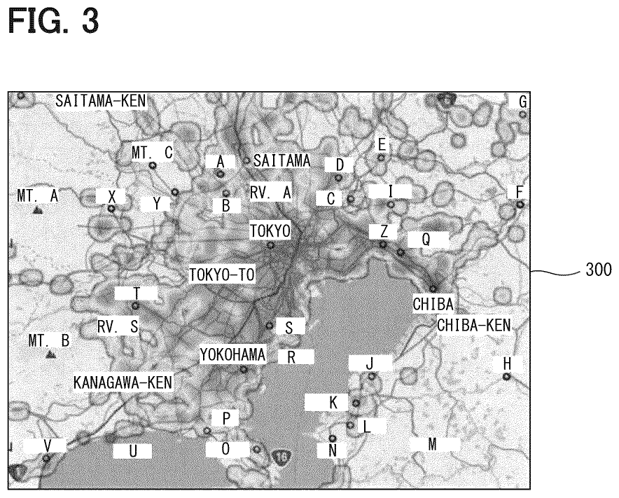

The server 10 creates a radio wave state map 300 illustrated in FIG. 3 for each communication carrier based on the position of wireless communication apparatus 200 and the radio wave intensity, which are included in the communication information transmitted from the wireless communication apparatus 200. In FIG. 3, the higher intensity of black indicates stronger radio wave intensity.

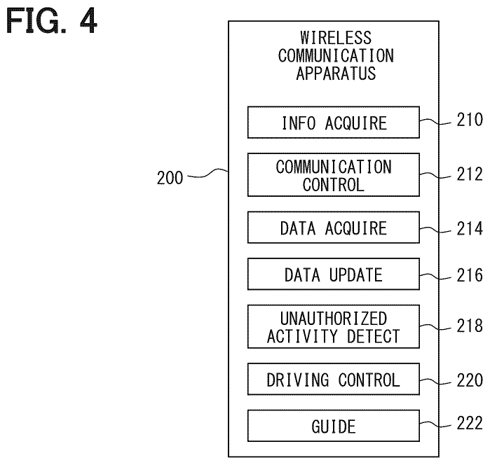

As illustrated in FIG. 4, the wireless communication apparatus 200 includes, as functional blocks, an information acquisition unit 210, a communication control unit 212, a data acquisition unit 214, a data update unit 216, an unauthorized activity detection unit 218, a driving control unit 220, and a guidance unit 222, which are implemented by the control unit 206 by executing a program stored in the eSIM 208.

The information acquisition unit 210 periodically acquires the above-described communication information. When a destination of the vehicle 100 and a route to the destination are set by a vehicle navigation device or the like (not illustrated), the information acquisition unit 210 acquires the destination and the route to the destination from the vehicle navigation device or the like. Hereinafter, the vehicle navigation device is also referred to as a vehicle navigation for short.

The communication control unit 212 periodically transmits the communication information from the wireless communication unit 204 to the server via the nearest base station 40. The communication control unit 212 transmits, to the server 10, the position of vehicle 100, the destination, and the route to the destination from the wireless communication unit 204.

The data acquisition unit 214 acquires the following data from the server at a position where the radio wave intensity is strong and communication between the wireless communication apparatus 200 and the base station 40 is possible.
(i) Map of the destination where the vehicle 100 is moving to.
(ii) Update data for updating a program of the wireless communication apparatus 200 of the vehicle 100 or a program of another ECU of the vehicle 100. The program may be software or firmware.
(iii) Radio wave intensity at the destination of the vehicle 100 or radio wave intensity of the route to the destination.
(iv) Congestion information, sightseeing information, local product information, and commercial information of the destination of vehicle 100.
(v) Radio wave intensity, disaster information, and risk information of the route to the destination of vehicle 100.

The server 10 acquires, from each vehicle 100 that communicates with the server 10, the radio wave intensity of the destination of vehicle 100 or the radio wave intensity of the route to the destination. The server 10 sets, as the congestion information of the destination of vehicle 100 described above, the number of vehicles 100 from which the communication information are transmitted at the destination. The disaster information may be information on an earthquake, heavy rain, or the like. The server 10 may set the risk information based on an occurrence rate of past accidents, a type of accident, or the like on the route on which the vehicle 100 is planned to travel.

Among the data acquired by the data acquisition unit 214 from the server the data update unit 216 updates the program of the wireless communication apparatus 200 with the update data prepared for updating purpose for the program of the wireless communication apparatus 200. The update data for the program of vehicle ECU other than the wireless communication apparatus 200 is transmitted from the data acquisition unit 214 to the corresponding vehicle ECU via an in-vehicle network.

The unauthorized activity detection unit 218 detects whether the data of wireless communication apparatus 200, which includes the program stored in the eSIM 208, is illegally changed. The unauthorized activity detection unit 218 detects whether the wireless communication apparatus 200 has accessed an unauthorized site via the network 30.

When the unauthorized activity detection unit 218 detects that the data in the eSIM 208 has been illegally changed or the wireless communication apparatus 200 has accessed an unauthorized site via the network 30, the communication control unit 212 notifies the server 10 of the unauthorized change or the unauthorized access.

When the unauthorized activity detection unit 218 detects the unauthorized change or the unauthorized access, the communication control unit 212 or the server 10 stops the communication between the base station 40 and the wireless communication apparatus 200.

In the following cases, the driving control unit 220 controls the vehicle 100 to travel on the route along which the vehicle 100 is planned to travel by an autonomous driving of the vehicle 100 performed by an autonomous driving system of the vehicle 100 or by a manual driving of the vehicle 100 performed by a driver of the vehicle, instead of an autonomous driving instructed by the service center 20 through performing a communication with the vehicle 100.
(i) When the communication with the service center 20 becomes difficult because the radio wave intensity indicated by the radio wave state map 300 acquired from the server 10 is weak.
(ii) When the autonomous driving instructed by the service center 20 becomes difficult based on the disaster information acquired by the data acquisition unit 214.

The guidance unit 222 guides the sightseeing information, the local product information, the commercial information, and the like described above toward inside of the vehicle using an image displayed on a display device or a sound output from a speaker as guide information regarding the destination to which the vehicle 100 is planned to move. The guidance unit 222 guides disaster information and risk information of the route to the destination, which the vehicle 100 is planned to travel, toward inside of the vehicle using an image displayed on the display device or a sound output from the speaker.

### 2. Process

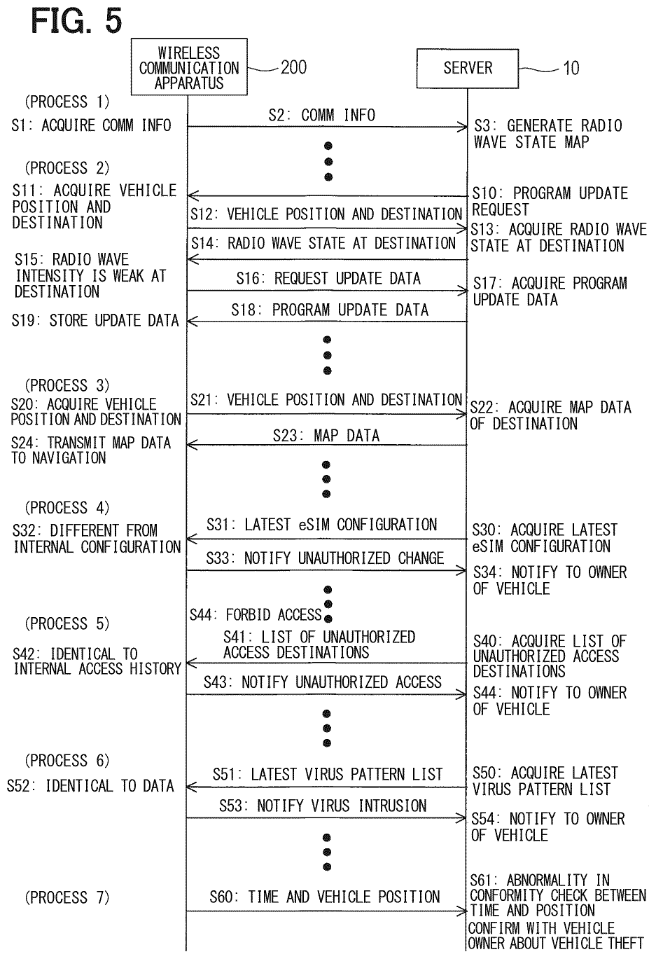

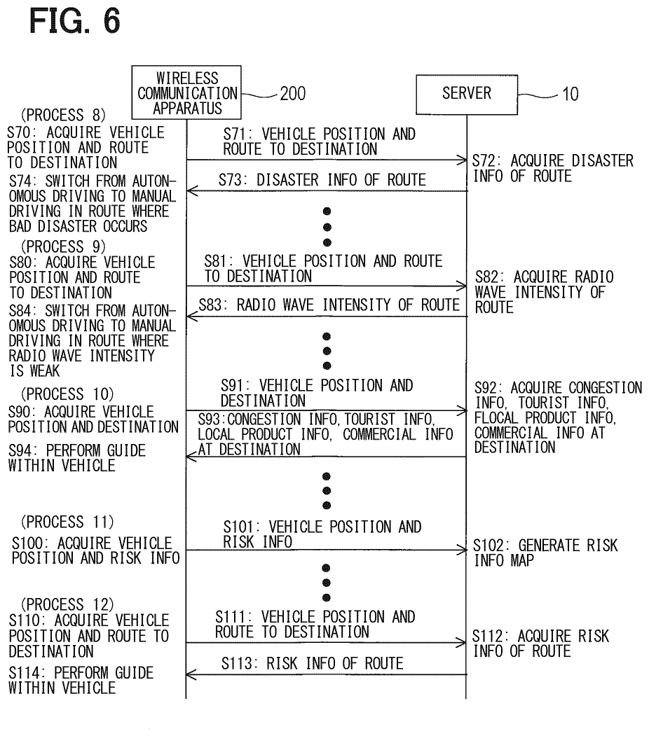

The following will describe a wireless communication process executed by the wireless communication apparatus 200 with reference to sequence diagrams of FIG. 5 and FIG. 6.

(Process 1)

The process 1 shown in FIG. 5 is periodically executed, for example, at predetermined time intervals. In S1, the information acquisition unit 210 acquires the following information as the communication information.
(i) Position of vehicle 100.
(ii) Position of base station 40.
(iii) Wireless communication carrier.
(iv) Radio wave intensity of wireless communication.
(v) Generation of wireless communication, such as 2G, 3G, 4G, or 5G.

In S2, the communication control unit 212 transmits the above-described communication information acquired by the information acquisition unit 210 to the server 10.

In S3, the server 10 creates the radio wave state map 300 indicating the radio wave intensity at the position of each vehicle 100 based on the communication information acquired from each vehicle 100.

(Process 2)

The process 2 in FIG. 5 is executed when there is a request to update the program of wireless communication apparatus 200 or the program of vehicle ECU.

In S10, the server 10 notifies the wireless communication apparatus 200 that there is a request to update the program of wireless communication apparatus 200 or the program of vehicle ECU. In S11, the information acquisition unit 210 acquires the position and the destination of the vehicle 100 from the navigation device of the vehicle 100. In S12, the communication control unit 212 transmits the position and the destination of the vehicle 100 to the server 10.

In S13, the server 10 acquires the radio wave intensity at the destination from the radio wave state map 300. In S14, the server 10 transmits the acquired radio wave intensity to the wireless communication apparatus 200. In S15, the data acquisition unit 214 determines whether the radio wave intensity at the destination acquired from the server 10 is strong enough to receive the update data of the program from the server 10. When the radio wave intensity at the destination is strong enough, the data acquisition unit 214 determines that the update data can be acquired from the server 10 at the destination, and does not acquire the update data at the current position of the vehicle 100.

When the radio wave intensity at the destination is weak, the data acquisition unit 214 determines that it is difficult to acquire the update data by the wireless communication at the destination. In this case, as shown in S16, the communication control unit 212 transmits, to the server 10, the position of vehicle 100 and the request for update data. When there is no response from the server 10 within a predetermined time period, the communication control unit 212 repeats S16.

When the communication with the wireless communication apparatus 200 is determined to be possible at the position of vehicle 100 received in S16 based on the radio wave state map 300, the server 10 acquires, in S17, update data corresponding to the vehicle 100 that has requested the update data. In S18, the server 10 transmits the acquired update data to the corresponding vehicle 100.

In S19, the data acquisition unit 214 stores the update data acquired from the server 10 in order to update the program when the vehicle 100 stops.

(Process 3)

The process 3 in FIG. 5 is executed when the destination of vehicle 100 and the route to the destination are set in the vehicle navigation device.

In S20, the information acquisition unit 210 acquires the position of vehicle 100 and the destination of vehicle 100 from the vehicle navigation device. In S21, the communication control unit 212 transmits the position and the destination of the vehicle 100 to the server 10. When there is no response from the server 10 within a predetermined time period, the communication control unit 212 repeats S21.

When the communication with the wireless communication apparatus 200 is determined to be possible at the position of the vehicle 100 received in S21 based on the radio wave state map 300, the server 10 acquires map data of the destination of the corresponding vehicle 100 in S22. In S23, the server 10 transmits the map data of the destination to the corresponding vehicle 100. In S24, the data acquisition unit 214 transmits the map data acquired from the server 10 to the vehicle navigation device via the in-vehicle network.

(Process 4)

The process 4 shown in FIG. 5 is periodically executed, for example, at predetermined time intervals. When acquiring the latest configuration of eSIM 208 of the target vehicle 100 in S30, the server 10 transmits the latest configuration of eSIM 208 to the target vehicle 100 in S31.

In S32, the unauthorized activity detection unit 218 detects unauthorized change by determining whether the actual configuration of eSIM 208 matches the configuration of eSIM 208 acquired from the server 10, which corresponds to internal configuration of eSIM 208. When the actual configuration of eSIM 208 matches the configuration of eSIM 208 acquired from the server 10, the unauthorized activity detection unit 218 determines that there is no unauthorized change and does not execute further measure. In the present disclosure, for example, one data matches another data may include a case where one data is identical to or substantially equivalent to another data.

When the actual configuration of eSIM 208 does not match the configuration of eSIM 208 acquired from the server 10, the unauthorized activity detection unit 218 determines that unauthorized change of data stored in the eSIM 208 has been detected. When the unauthorized activity detection unit 218 detects that the configuration of eSIM 208 has been tampered with, the communication control unit 212 transmits information indicating that the configuration of eSIM has been tampered with to the server 10 in S33.

The server 10 that has received the unauthorized change of the eSIM 208 notifies, in S34, the owner of the vehicle 100 of the unauthorized change by, for example, e-mail, telephone, or the like. Alternatively, in S 34, the server 10 may prohibit the base station 40 to perform the wireless communication with the vehicle 100 that has been tampered with.

(Process 5)

The process 5 shown in FIG. 5 is periodically executed, for example, at predetermined time intervals. When acquiring the latest unauthorized access destination list in S40, the server 10 transmits, in S41, the unauthorized access destination list to the target vehicle 100. The unauthorized access destination list includes list of sites and the like that may be infected with a virus when being accessed.

In S42, the unauthorized access detection unit 218 detects an unauthorized access by determining whether the unauthorized access destination list acquired from the server 10 partially matches the recorded access destination list which have been accessed by the wireless communication apparatus 200. When the unauthorized access destination list acquired from the server 10 does not match the recorded access destination list which have been accessed by the wireless communication apparatus 200, the unauthorized access detection unit 218 determines that unauthorized access has not been performed and does not execute further measure.

When the unauthorized access destination list acquired from the server 10 partially matches the recorded access destination list which have been accessed by the wireless communication apparatus 200, the unauthorized access detection unit 218 determines that the unauthorized access has been performed. When the unauthorized access detection unit 218 detects the unauthorized access, the communication control unit 212 notifies, in S43, the server 10 of the unauthorized access.

In S44, the server 10 notifies the owner of the vehicle 100 of an occurrence of unauthorized access by the vehicle 100, for example, by e-mail, telephone, or the like. Alternatively, in S44, the server 10 may prohibit the base station 40 to perform the wireless communication with the vehicle 100 that has performed an unauthorized access.

(Process 6)

The process 6 shown in FIG. 5 is periodically executed, for example, at predetermined time intervals. When acquiring latest virus pattern list in S50, the server 10 transmits, in S51, the acquired virus pattern list to the target vehicle 100.

In S52, the unauthorized activity detection unit 218 detects intrusion of a virus by comparing the virus pattern list acquired from the server 10 with data, which is stored in the memory of the control unit 206 or the eSIM 208 of the wireless communication apparatus 200. When the data stored in the wireless communication apparatus 200 does not match the virus pattern list, the unauthorized activity detection unit 218 determines that there is no virus intrusion and does not execute further measure.

When the data stored in the wireless communication apparatus 200 matches a part of the virus pattern list, the unauthorized activity detection unit 218 determines intrusion of virus to the wireless communication apparatus 200. When the unauthorized activity detection unit 218 detects the intrusion of virus, the communication control unit 212 transmits, to the server 10, information indicating intrusion of virus to the wireless communication apparatus 200 in S53.

In S54, the server 10 notifies the owner of vehicle 100 of the intrusion of virus, for example, by e-mail, telephone, or the like. Alternatively, in S54, the server may prohibit the base station 40 to perform wireless communication with the vehicle 100 to which the virus has intruded.

(Process 7)

The process 7 shown in FIG. 5 is periodically executed, for example, at predetermined time intervals.

In S60, the communication control unit 212 transmits the current time and the position of vehicle 100 to the server 10. In S61, when a relationship between the current time and the position of vehicle 100 is not a normal pattern, the server 10 may determine that there is a possibility that the vehicle 100 has been stolen, and confirms with the owner of the vehicle 100 whether the vehicle 100 has been stolen by e-mail, telephone, or the like.

The case where the relationship between the current time and the position of vehicle 100 is not the normal pattern is, for example, driving of the vehicle 100 at the position at the time is not normal for the owner of the vehicle 100.

(Process 8)

The process 8 shown in FIG. 6 is executed when the destination of vehicle 100 and the route to the destination are set in the vehicle navigation device.

In S70, the information acquisition unit 210 acquires the position of vehicle 100 and the route to the destination of vehicle 100 from the vehicle navigation device. In S71, the communication control unit 212 transmits, to the server 10, the position of vehicle 100 and the route to the destination of vehicle 100. When there is no response from the server 10 within a predetermined time period, the communication control unit 212 repeats S71.

When the communication with the wireless communication apparatus 200 is determined to be possible at the position of vehicle 100 received in S71 based on the radio wave state map 300, the server 10 acquires, in S72, disaster information on the route to the destination of the corresponding vehicle 100. In S73, the server 10 transmits the acquired disaster information on the route to the corresponding vehicle 100.

In S74, the data acquisition unit 214 acquires disaster information on the route from the server 10. When it is determined that the disaster state is bad and the autonomous driving is difficult in response to the disaster information acquired by the data acquisition unit 214, the driving control unit 220 switches from the autonomous driving to the manual driving performed by the driver. The autonomous driving of the vehicle 100 may be performed by the instruction from the service center 20 or may be performed by the autonomous driving system of the vehicle 100 itself.

(Process 9)

The process 9 shown in FIG. 6 is executed when the destination of vehicle 100 and the route to the destination are set in the vehicle navigation device.

In S80, the information acquisition unit 210 acquires the position of vehicle 100 and the route to the destination of vehicle 100 from the vehicle navigation device. In S81, the communication control unit 212 transmits, to the server 10, the position of vehicle 100 and the route to the destination of vehicle 100. When there is no response from the server 10 within a predetermined time period, the communication control unit 212 repeats S81.

When the communication with the wireless communication apparatus 200 is determined to be possible at the position of vehicle 100 received in S81 based on the radio wave state map 300, the server 10 acquires, in S82, the radio wave state map 300 indicating the radio wave intensity on the route to the destination of the corresponding vehicle 100. In S83, the server 10 transmits, to the corresponding vehicle 100, the radio wave intensity on the route to the destination.

In S84, the data acquisition unit 214 acquires the radio wave intensity on the route from the server 10. Based on the radio wave intensity of the route acquired by the data acquisition unit 214, the driving control unit 220 determines whether the route includes a section in which the autonomous driving is difficult to be performed based on the wireless communication with outside source, such as the service center.

When the route does not include a section in which the autonomous driving is difficult to be performed based on the wireless communication, the driving control unit 220 continues autonomous driving by performing the wireless communication with the outside source, such as the service center.

When the route includes a section in which the autonomous driving is difficult to be performed based on the wireless communication, the driving control unit 220 switches the autonomous driving performed based on the wireless communication to the autonomous driving performed by the autonomous driving system of the vehicle 100 itself or switches to the manual driving performed by the driver on the corresponding section of route.

(Process 10)

The process 10 shown in FIG. 6 is executed when the destination of vehicle 100 and the route to the destination are set in the vehicle navigation device.

In S90, the information acquisition unit 210 acquires the position of vehicle 100 and the destination of vehicle 100 from the vehicle navigation device. In S91, the communication control unit 212 transmits the position and the destination of the vehicle 100 to the server 10. When there is no response from the server 10 within a predetermined time period, the communication control unit 212 repeats S91.

When the communication with the wireless communication apparatus 200 is determined to be possible at the position of the vehicle 100 received in S91 based on the radio wave state map 300, the server 10 acquires, in S92, guide information, such as congestion information, sightseeing information, local product information, and commercial information at the destination of the corresponding vehicle 100.

In S93, the server 10 transmits the acquired guide information at the destination to the corresponding vehicle 100. In S94, the data acquisition unit 214 acquires the guide information of the destination from the server 10. The guidance unit 222 presents the guidance information of the destination acquired by the data acquisition unit 214 toward inside of the vehicle by an image or a sound.

(Process 11)

Process 11 shown in FIG. 6 is executed when the information acquisition unit 210 acquires the risk information. The information acquisition unit 210 may acquire, as the risk information, unevenness portion of a road on which the vehicle 100 is traveling, rock fall, freezing, snow accumulation, dense fog, heavy rain, and the like around the vehicle 100 from the detection result detected by another ECU of the vehicle 100.

When the information acquisition unit 210 acquires the risk information in S100, the communication control unit 212 transmits the position of the vehicle 100 and the danger information to the server 10 in S101. In S102, the server 10 generates a risk information map based on the position and the risk information acquired from each vehicle 100.

(Process 12)

The process 12 shown in FIG. 6 is executed when the destination of vehicle 100 and the route to the destination are set in the vehicle navigation device.

In S110, the information acquisition unit 210 acquires the position of vehicle 100 and the route to the destination of vehicle 100 from the vehicle navigation device. In S111, the communication control unit 212 transmits, to the server 10, the position of vehicle 100 and the route to the destination of vehicle 100. When there is no response from the server 10 within a predetermined time period, the communication control unit 212 repeats S111.

When the communication with the wireless communication apparatus 200 is determined to be possible at the position of vehicle 100 received in S111 based on the radio wave state map 300, the server 10 acquires, in S112, risk information on the route of the corresponding vehicle 100 based on the risk information map generated in process 11. In S113, the server 10 transmits the acquired risk information on the route to the corresponding vehicle 100.

In S114, the data acquisition unit 214 acquires the risk information on the route from the server 10. The guidance unit 222 guides the risk information on the route, which is acquired by the data acquisition unit 214 from the server 10, toward inside of the vehicle by an image or a sound.

In the present embodiment described above, the control unit 206 and the eSIM 208 correspond to a computer of the wireless communication apparatus 200, and the eSIM 208 corresponds to a storage medium. The process executed in S1, S11, S20, S70, S80, S90, and S110 correspond the information acquisition unit 210. The process executed in S2, S12, S21, S33, S43, S53, S71, S81, S91, and S111 correspond to the communication control unit 212. The process executed in S15, S19, S24, S74, S84, S94, and S114 correspond to the data acquisition unit 214. The process executed in S32, S42, and S52 correspond to the unauthorized activity detection unit 218. The process executed in S74 and S84 correspond to the driving control unit 220. The process executed in S114 corresponds to the guidance unit 222.

### 3. Effects

The embodiment described above provides the following effects.
(3a) The wireless communication apparatus 200 transmits, to the server communication information including at least the radio wave intensity of wireless communication to be performed with the base station 40 at the position of the wireless communication apparatus 200 and the position of the wireless communication apparatus 200. Accordingly, the communication information acquired from the wireless communication apparatus 200 can be effectively used not only for the wireless communication apparatus 200 but also for the server 10 to generate the radio wave state map 300 based on the communication information.
(3b) When performing update of the program of the wireless communication apparatus 200 or the vehicle ECU during driving state of the vehicle 100, there is a possibility that the vehicle 100 may fail to perform communication or fail to perform traveling control. Thus, the program is updated when the vehicle 100 arrives at the destination and the driving of the vehicle 100 is stopped.

When the radio wave intensity at the destination is weak and the update data cannot be received from the server 10, the vehicle 100 may fail to acquire the update data of the program from the server 10 when the vehicle 100 arrives at the destination and stops driving.

Thus, when the radio wave intensity at the destination is weak, the update data is acquired from the server 10 and stored while the vehicle 100 is traveling before arriving at the destination. With this configuration, the program can be updated with the stored update data when the vehicle 100 arrives at the destination.
(3c) The server 10 transmits the program update data, the map data of the destination, the disaster information of the route, the radio wave intensity of the route, the risk information of the route, and the like to the wireless communication apparatus 200 at a position where the communication with the wireless communication apparatus 200 is possible based on the radio wave state map 300. With this configuration, it is possible to suppress transmission loss of data from the server 10 to the wireless communication apparatus 200.

### 4. Other Embodiments

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.
(4a) The wireless communication apparatus 200 described above may be a vehicle wireless communication apparatus for use of the vehicle 100, or may be implemented by a device, such as a portable terminal, or a smartphone carried by a user and being connected to the vehicle 100.
(4b) The wireless communication apparatus 200 described above is not limited to a device mounted on the vehicle 100, and may be a device carried by a user which is carried together with the user, such as a smartphone.
(4c) The above-described wireless communication apparatus 200 includes the eSIM 208 as a storage medium. The present disclosure is not limited to this configuration. A storage medium other than the eSIM 208 may be used under a condition that the functions of the wireless communication apparatus 200 in the above-described embodiment can be implemented by the storage medium. The wireless communication apparatus 200 may function as a TCU. TCU is an abbreviation for Telematics Control Unit.
(4d) In the above-described embodiment, the wireless communication apparatus 200 detects the unauthorized access of the wireless communication apparatus 200 based on the unauthorized access destination list acquired from the server 10. Alternatively, the server 10 may acquire the access destination of the wireless communication apparatus 200 from the base station 40 and detect the unauthorized access of the wireless communication apparatus 200.
(4e) The wireless communication apparatus 200 and a method thereof described in the present disclosure may be implemented by a dedicated computer provided by configuring a processor and a memory programmed to execute one or multiple functions provided by execution of a computer program.

Alternatively, the wireless communication apparatus 200 and a method thereof described in the present disclosure may be implemented by a dedicated computer, which is provided by a processor including one or more dedicated hardware logic circuits.

Alternatively, the wireless communication apparatus 200 and a method thereof described in the present disclosure may be implemented by one or more dedicated computers, which are configured as a combination of a processor and a memory programmed to perform one or more functions, and a processor which is configured with one or more hardware logic circuits.

The computer program may be stored in a computer-readable non-transitory tangible storage medium as instructions to be executed by the computer, and is not limited to the eSIM 208 described above. The technique for implementing the functions of the respective units included in the wireless communication apparatus 200 does not necessarily include software, and all of the functions may be implemented by one or more hardware circuits.
(4f) The multiple functions of one component in the above embodiments may be implemented by multiple components, or a function of one component may be implemented by multiple components. Multiple functions of multiple elements may be implemented by one element, or one function implemented by multiple elements may be implemented by one element. A part of the configuration of the above embodiment may be omitted as appropriate. At least a part of the configuration of the above embodiment may be added to or replaced with another configuration of the above embodiment.
(4g) The present disclosure can be implemented by, in addition to the wireless communication apparatus 200 described above, various forms such as a system including the wireless communication apparatus 200 as a configuration element, a program controlling a computer to function as the wireless communication apparatus 200, a non-transitory tangible storage medium such as a semiconductor memory storing the program, and a wireless communication method.

The present disclosure includes the following technical aspects.

(Aspect 1)

A non-transitory tangible storage medium storing a program to be executed by a computer of a wireless communication apparatus, the wireless communication apparatus performing a wireless communication in a moving state via a base station, instructions of the program stored in the storage medium comprising:
acquiring communication information including at least a position of the wireless communication apparatus and a radio wave intensity of the wireless communication with the base station at the position of the wireless communication apparatus; and
transmitting, via the base station, the acquired communication information to a server, the server generating a radio wave state map indicating the radio wave intensity at the position of the wireless communication apparatus based on the received communication information.

(Aspect 2)

The storage medium according to aspect 1, wherein the instructions of the program stored in the storage medium further includes:
acquiring a destination to which the wireless communication apparatus is planned to move; and
transmitting, to the server via the base station, the destination and the position of the wireless communication apparatus.

(Aspect 3)

The storage medium according to aspect 3, wherein the instructions of the program stored in the storage medium further includes acquiring, from the server, update data of the program at a position where the wireless communication with the server via the base station is determined to be possible before arriving at the destination based on the radio wave state map, in response to the wireless communication with the server via the base station being determined to be difficult at the destination based on the radio wave state map.

(Aspect 4)

The storage medium according to aspect 2 or 3, wherein the instructions of the program stored in the storage medium further includes acquiring, at a position where the wireless communication with the server via the base station is determined to be possible before arriving at the destination based on the radio wave state map, at least one of (i) a map of the destination, (ii) congestion information of the destination indicated by a quantity of the wireless communication apparatuses existing at the destination, (iii) sightseeing information of the destination, (iv) local product information of the destination, or (v) commercial information of the destination, from the server.

(Aspect 5)

The storage medium according to aspect 4, wherein the instructions of the program stored in the storage medium further includes, in response to acquiring at least one of (i) the congestion information of the destination, (ii) the sightseeing information of the destination, (iii) the local product information of the destination, or (iv) the commercial information of the destination, from the server, performing a guidance about the acquired information.

(Aspect 6)

The storage medium according to any one of aspects 1 to 5, wherein the instructions of the program stored in the storage medium further includes:
acquiring a route to a destination to which the wireless communication apparatus is planned to move;
transmitting the route and the position of the wireless communication apparatus to the server via the base station; and
acquiring, at a position where the wireless communication with the server via the base station is determined to be possible before arriving at the destination based on the radio wave state map, at least one of (i) a radio wave intensity of the route, (ii) disaster information of the route, or (iii) risk information when traveling the route, from the server.

(Aspect 7)

The storage medium according to aspect 6, wherein:
the wireless communication apparatus is mounted on a vehicle capable of performing autonomous driving; and
the instructions of the program stored in the storage medium further includes, in response to acquiring the disaster information of the route from the server, instructing a driver of the vehicle to perform a driving operation at a position of the route where the autonomous driving is determined to be difficult based on the acquired disaster information.

(Aspect 8)

The storage medium according to aspect 6, wherein:
the wireless communication apparatus is mounted on a vehicle capable of performing autonomous driving according to instructions received by the wireless communication, which is performed via the base station; and
the instructions of the program stored in the storage medium further includes, in response to acquiring the radio wave intensity of the route from the server, disabling the autonomous driving performed according to the instructions received by the wireless communication at a position of the route where the autonomous driving performed according to the instructions received by the wireless communication is determined to be difficult based on the acquired radio wave intensity of the route.

(Aspect 9)

The storage medium according to aspect 6, wherein the instructions of the program stored in the storage medium further includes performing a guidance about the risk information in response to acquiring of the risk information from the server.

(Aspect 10)

The storage medium according to any one of aspects 1 to 9, wherein the instructions of the program stored in the storage medium further includes:
detecting an unauthorized change of data stored in the wireless communication apparatus or an intrusion of virus into the wireless communication apparatus; and
in response to detecting the unauthorized change of data stored in the wireless communication apparatus or the intrusion of virus into the wireless communication apparatus, notifying, to the server, the unauthorized change or the intrusion of virus.

(Aspect 11)

The storage medium according to any one of aspects 1 to 10, wherein the instructions of the program stored in the storage medium further includes:
detecting an unauthorized access by the wireless communication of the wireless communication apparatus; and
in response to detecting the unauthorized access by the wireless communication of the wireless communication apparatus, notifying, to the server, the unauthorized access.

(Aspect 12)

A wireless communication apparatus that performs a wireless communication via a base station in a moving state, the wireless communication apparatus comprising:
a computer-readable non-transitory storage medium; and
a computer, by executing a program stored in the computer-readable non-transitory storage, configured to:
   acquire communication information including at least a position of the wireless communication apparatus and a radio wave intensity of the wireless communication with the base station at the position of the wireless communication apparatus; and
   transmit, via the base station, the acquired communication information to a server, the server generating a radio wave state map indicating the radio wave intensity at the position of the wireless communication apparatus based on the received communication information.

(Aspect 13)

A wireless communication method executed by a computer of a wireless communication apparatus, the wireless communication apparatus performing a wireless communication via a base station in a moving state, the wireless communication method comprising:
acquiring communication information including at least a position of the wireless communication apparatus and a radio wave intensity of the wireless communication with the base station at the position of the wireless communication apparatus; and
transmitting, via the base station, the acquired communication information to a server, the server generating a radio wave state map indicating the radio wave intensity at the position of the wireless communication apparatus based on the received communication information.

What is claimed is:

1. A non-transitory tangible storage medium storing a program to be executed by a computer of a wireless communication apparatus, the wireless communication apparatus performing a wireless communication in a moving state via a base station, instructions of the program stored in the storage medium comprising:
acquiring communication information including at least a position of the wireless communication apparatus and a radio wave intensity of the wireless communication with the base station at the position of the wireless communication apparatus; and
transmitting, via the base station, the acquired communication information to a server, the server generating a radio wave state map indicating the radio wave intensity at the position of the wireless communication apparatus based on the received communication information.

2. The storage medium according to claim 1, wherein the instructions of the program stored in the storage medium further includes:
acquiring a destination to which the wireless communication apparatus is planned to move; and
transmitting, to the server via the base station, the destination and the position of the wireless communication apparatus.

3. The storage medium according to claim 2, wherein the instructions of the program stored in the storage medium further includes
acquiring, from the server, update data of the program at a position where the wireless communication with the server via the base station is determined to be possible before arriving at the destination based on the radio wave state map, in response to the wireless communication with the server via the base station being determined to be difficult at the destination based on the radio wave state map.

4. The storage medium according to claim 2, wherein the instructions of the program stored in the storage medium further includes
acquiring, at a position where the wireless communication with the server via the base station is determined to be possible before arriving at the destination based on the radio wave state map, at least one of (i) a map of the destination, (ii) congestion information of the destination indicated by a quantity of the wireless communication apparatuses existing at the destination, (iii) sightseeing information of the destination, (iv) local product information of the destination, or (v) commercial information of the destination, from the server.

5. The storage medium according to claim 4, wherein the instructions of the program stored in the storage medium further includes
in response to acquiring at least one of (i) the congestion information of the destination, (ii) the sightseeing information of the destination, (iii) the local product information of the destination, or (iv) the commercial information of the destination, from the server, performing a guidance about the acquired information.

6. The storage medium according to claim 1, wherein the instructions of the program stored in the storage medium further includes:
acquiring a route to a destination to which the wireless communication apparatus is planned to move;
transmitting the route and the position of the wireless communication apparatus to the server via the base station; and
acquiring, at a position where the wireless communication with the server via the base station is determined to be possible before arriving at the destination based on the radio wave state map, at least one of (i) a radio wave intensity of the route, (ii) disaster information of the route, or (iii) risk information when traveling the route, from the server.

7. The storage medium according to claim 6, wherein
the wireless communication apparatus is mounted on a vehicle capable of performing autonomous driving, and
the instructions of the program stored in the storage medium further includes, in response to acquiring the disaster information of the route from the server, instructing a driver of the vehicle to perform a driving operation at a position of the route where the autonomous driving is determined to be difficult based on the acquired disaster information.

8. The storage medium according to claim 6, wherein
the wireless communication apparatus is mounted on a vehicle capable of performing autonomous driving according to instructions received by the wireless communication, which is performed via the base station, and
the instructions of the program stored in the storage medium further includes, in response to acquiring the radio wave intensity of the route from the server, disabling the autonomous driving performed according to the instructions received by the wireless communication at a position of the route where the autonomous driving performed according to the instructions received by the wireless communication is determined to be difficult based on the acquired radio wave intensity of the route.

9. The storage medium according to claim 6, wherein the instructions of the program stored in the storage medium further includes
performing a guidance about the risk information in response to acquiring of the risk information from the server.

10. The storage medium according to claim 1, wherein the instructions of the program stored in the storage medium further includes:
detecting an unauthorized change of data stored in the wireless communication apparatus or an intrusion of virus into the wireless communication apparatus; and
in response to detecting the unauthorized change of data stored in the wireless communication apparatus or the intrusion of virus into the wireless communication apparatus, notifying, to the server, the unauthorized change or the intrusion of virus.

11. The storage medium according to claim 1, wherein the instructions of the program stored in the storage medium further includes:
detecting an unauthorized access by the wireless communication of the wireless communication apparatus; and
in response to detecting the unauthorized access by the wireless communication of the wireless communication apparatus, notifying, to the server, the unauthorized access.

12. A wireless communication apparatus that performs a wireless communication via a base station in a moving state, the wireless communication apparatus comprising:
a computer-readable non-transitory storage medium; and
a computer, by executing a program stored in the computer-readable non-transitory storage, configured to:
acquire communication information including at least a position of the wireless communication apparatus and a radio wave intensity of the wireless communication with the base station at the position of the wireless communication apparatus; and
transmit, via the base station, the acquired communication information to a server, the server generating a radio wave state map indicating the radio wave intensity at the position of the wireless communication apparatus based on the received communication information.

13. A wireless communication method executed by a computer of a wireless communication apparatus, the wireless communication apparatus performing a wireless communication via a base station in a moving state, the wireless communication method comprising:
acquiring communication information including at least a position of the wireless communication apparatus and a radio wave intensity of the wireless communication with the base station at the position of the wireless communication apparatus; and
transmitting, via the base station, the acquired communication information to a server, the server generating a radio wave state map indicating the radio wave intensity at the position of the wireless communication apparatus based on the received communication information.
